(19) United States
(12) Patent Application Publication
(10) Pub. No.: US 2024/0219104 A1
(43) Pub. Date: Jul. 4, 2024

(54) REFRIGERATOR

(71) Applicant: SAMSUNG ELECTRONICS CO., LTD., Suwon-si (KR)

(72) Inventors: Suhyeong LIM, Suwon-si (KR); Seongwoo KIM, Suwon-si (KR); Jaejin LEE, Suwon-si (KR)

(73) Assignee: SAMSUNG ELECTRONICS CO., LTD., Suwon-si (KR)

(21) Appl. No.: 18/383,377

(22) Filed: Oct. 24, 2023

Related U.S. Application Data
(63) Continuation of application No. PCT/KR2023/014016, filed on Sep. 18, 2023.

(30) Foreign Application Priority Data
Dec. 28, 2022 (KR) 10-2022-0187733

(51) Int. Cl. F25D 23/02; E05F 15/619

(52) U.S. Cl. CPC F25D 23/028; E05F 15/619; E05Y 2201/46; E05Y 2201/708; E05Y 2900/31; F25D 2323/021; F25D 2323/024

(57) ABSTRACT

A refrigerator includes a main body having a storage compartment, and a door rotatably coupled to the main body to open or close the storage compartment. The refrigerator includes a slider provided on the main body, and is configured to movable in a front-rear direction to open or close the door, the slider including a contact part. The refrigerator includes a magnetic force part installed to to the rear surface of the door so that the door is configured to be opened or closed by the slider while the magnetic force part is magnetically attached to the contact part. At least one of the contact part and a part of the magnetic force part is configured to be rotatable so that while the attachment of the magnetic force part and the contact part is maintained.

### CROSS REFERENCE TO THE RELATED APPLICATION

This application is a continuation application, filed under 35 U.S.C. § 111(a), of International Application PCT/KR2023/014016 filed Sep. 18, 2023, and is based on and claims priority under 35 U.S.C. § 119 to Korean Patent Applications No. 10-2022-0187733, filed on Dec. 28, 2022 in the Korean Intellectual Property Office, the disclosures of which are incorporated by reference herein in their entireties.

### TECHNICAL FIELD

The present disclosure relates to a refrigerator with an improved device for opening and closing a door.

### BACKGROUND ART

A refrigerator is an apparatus including a main body having a storage compartment and a cold air supply system for supplying cold air to the storage compartment, thereby keeping foods fresh. The storage compartment include a refrigerating compartment that is kept at temperature of about 0 degrees Celsius to 5 degrees Celsius to keep foods refrigerated, and a freezing compartment that is kept at temperature of about 0 degrees Celsius to −30 degrees Celsius to keep foods frozen. A door may be provided at the front of the main body to open and close the storage compartment. The door may be rotatably provided at the front of the main body to open and close the storage compartment.

The refrigerator may be provided with a device for opening the door so that the door may be easily opened. When the door is closed, air inside the storage compartment is cooled, resulting in a temperature difference between the inside and outside of the storage compartment, and thus a pressure difference between the inside and outside of the storage compartment may occur. In addition, the door is closely attached to the main body by a gasket including a magnet so that the storage compartment is sealed. Therefore, when opening the door, a lot of force may be required at an initial stage of opening.

Because the door is opened at a certain angle when a user operates a device for opening the door, the user may open the door using a small force.

### DISCLOSURE

### Technical Problem

The present disclosure is directed to a refrigerator capable of being automatically closed when a door partially opened by a slider is no longer opened.

The present disclosure is directed to a refrigerator in which a magnet is provided on a slider for opening a door and/or a surface of the door in contact with the slider so that the door partially opened by the slider may be automatically closed by the slider.

The present disclosure is directed to a refrigerator in which a slider for opening a door and/or a surface of the door in contact with the slider is rotated depending on an angle at which the door is opened and closed so that the slider and/or the surface of the door in contact with the slider is kept parallel when the door is opened and closed.

Technical tasks to be achieved in this document are not limited to the technical tasks mentioned above, and other technical tasks not mentioned will be clearly understood by those skilled in the art from the description below.

### Technical Solution

An aspect of the present disclosure provides a refrigerator including a main body having a storage compartment; a door rotatably coupled to the main body to open or close the storage compartment; a slider provided on the main body, configured to be movable in a front-rear direction to open or close the door, the slider comprising a contact part; and a magnetic force part installed to a rear surface of the door, configured to be magnetically attachable to or detachable to the contact part by a movement of the slider.

The door may be configured to be opened or closed by the slider while the magnetic force part is magnetically attached to the contact part, and at least one of the contact part and a part of the magnetic force part may be configured to be rotatable so that while the attachment of the magnetic force part and the contact part is maintained.

The slider may further comprise a rack gear to allow the slider to be movable in the front-rear direction; and a housing provided at a front end of the slider, and having an opening.

The contact part may comprise a magnet partially accommodated in the housing; and a cover to cover the opening of the housing, and rotatably coupled to the housing so that the cover is configured to be rotatable with respect to the housing while the magnetic force part is magnetically attached to the contact part.

The housing may further comprise a pair of rotation protrusions formed at an upper portion and a lower portion of inside of the housing, respectively, so that the cover is rotatably coupled to the pair of rotation protrusions.

The main body may comprise a hinge shaft to which the door is rotatably coupled, and the pair of rotation protrusions are formed at a portion away from the hinge shaft of the door in a left-right direction with respect to a center of the housing.

The cover may comprise a pair of rotation holes to which the pair of rotation protrusions are rotatably coupled; and a pair of fixing hooks to which the magnet is fixed therebetween.

The magnet may be accommodated between the cover and the housing so that the magnet is prevented from being exposed to outside of the slider, and the magnet is fixed to the pair of fixing hooks to be rotated together with the cover.

The magnetic force part may comprise a case having an opening, and installed to the rear surface of the door; a housing having an opening, and accommodated inside of the case by inserting into the opening of the case; a magnet partially accommodated in the housing; and a cover to cover the opening of the housing, and rotatably coupled to the housing so that the cover is configured to be rotatable with respect to the housing while the magnetic force part is magnetically attached to the contact part.

The door may comprise an insertion hole formed on the rear surface of the door to allow a portion of the case to be inserted; a pair of assembly grooves formed at an upper portion and a lower portion of the insertion hole, respectively, to allow the case to be installed; and a pair of assembly portions formed on a left side and a right side of the insertion hole, respectively, to allow the case to be installed.

The case may further comprise an accommodation portion having an open front to accommodate the housing; a pair of assembly ribs provided at an upper portion and a lower portion of a rear surface of the case, respectively, to be installed into the pair of assembly grooves; and a pair of assembly hooks provided on a left side and a right side of the rear surface of the case, respectively, to be installed into the pair of assembly portions.

The case may further comprise a plurality of fixing grooves, and the housing may further comprise a plurality of case fixing hooks fixed to the plurality of fixing grooves; and a pair of rotation protrusions provided at an upper portion and a lower portion of inside of the housing, respectively, so that the cover is rotatably coupled to the pair of rotation protrusions.

The main body may comprise a hinge shaft to which the door is rotatably coupled, and the pair of rotation protrusions are formed at a portion away from a hinge shaft of the door in a left-right direction with respect to a center of the housing.

The cover may further comprise a pair of rotation holes to which the pair of rotation protrusions are rotatably; coupled and a pair of fixing hooks to which the magnet is fixed therebetween.

The magnet may be accommodated between the cover and the housing so that the magnet is prevented from being exposed to outside of the magnetic force part, and the magnet is fixed to the pair of fixing hooks to be rotated together with the cover.

The door may comprise: a first door and a second door provided on a left side and a right side of the main body, respectively, and the slider and the magnetic force part are provided as a pair to each of the first door and the second door.

### Advantageous Effects

According to embodiments of the present disclosure, when a door partially opened by a slider is no longer opened, the door can be automatically closed to seal the refrigerator.

In addition, the door can be automatically closed by a magnetic force of a magnet to seal the refrigerator.

In addition, the slider opening the door and/or a surface of the door in contact with the slider can be always kept parallel when the door is opened and closed so that the slider and/or the surface of the door in contact with the slider is kept in surface contact.

Effects obtainable from the present disclosure are not limited to the effects mentioned above, and other effects not mentioned will be clearly understood by those skilled in the art from the description below.

### DESCRIPTION OF DRAWINGS

FIG. 1 is a perspective view of a refrigerator according to an embodiment.

FIG. 2 is a view illustrating a state in which a door of the refrigerator is opened and a door opening and closing device for opening the door is separated according to an embodiment.

FIG. 3 is an enlarged view of a dotted line portion in FIG. 1 illustrating a switch of a first door.

FIG. 4 is a view illustrating the switch of the first door and a switch of a second door according to an embodiment.

FIG. 5 is a view illustrating that a door opening and closing device is provided on a main body and the door according to an embodiment.

FIG. 6 is an exploded view of a slider according to an embodiment.

FIG. 7 is a view for explaining a process of assembling a disassembled magnetic force part to a rear surface of the door according to an embodiment.

FIG. 8 illustrates a case in FIG. 7 that is viewed from another direction.

FIG. 9 is a view illustrating a state in which the door is closed according to an embodiment.

FIG. 10 is a view illustrating an elastic lever provided at an upper portion of the door and a cam member provided on an upper hinge when the door is closed according to an embodiment.

FIG. 11 is a view illustrating a state in which a contact part is attached to the magnetic force part as the slider in FIG. 9 is moved forward.

FIG. 12 is a perspective view illustrating the state in which the contact part is attached to the magnetic force part according to an embodiment.

FIG. 13 is a view illustrating that a cover of the magnetic force part is rotated while the door is opened as the slider is moved forward in FIG. 11.

FIG. 14 is a perspective view illustrating that the cover is rotated in the state in which the contact part is attached to the magnetic force part according to an embodiment.

FIG. 15 is a view illustrating states of the elastic lever and the cam member when the door is completely opened according to an embodiment.

FIG. 16 is a view illustrating that the door is completely opened in a state in which the door is partially opened by the slider according to an embodiment.

FIG. 17 is a view illustrating states of the elastic lever and the cam member when the door is partially opened according to an embodiment.

FIG. 18 is a view showing that the door is automatically closed by the slider in the state in which the door is partially opened by the slider according to an embodiment.

FIG. 19 is a view illustrating that the cover is rotated while the door is closed by the slider according to an embodiment.

FIG. 20 is a view illustrating that the slider returns to an original position thereof while the contact part of the slider is detached from the magnetic force part after the door is closed by the slider according to an embodiment.

FIG. 21 is a view illustrating that the magnetic force part is provided with a magnet, and the contact part is not provided with a magnet, but is provided with a cover made of iron, according to an embodiment.

FIG. 22 is a view illustrating that the contact part is provided with the magnet, and the magnetic force part is not provided with the magnet, but is provided with the cover made of iron, according to an embodiment.

FIG. 23 is an exploded view illustrating the slider according to an embodiment.

FIG. 24 is a view for explaining a process of assembling a disassembled magnetic force part to the rear surface of the door according to an embodiment.

FIG. 25 is a view illustrating a state in which a contact part is attached to a magnetic force part as the slider is moved forward in the state in which the door is closed according to an embodiment.

FIG. 26 is a view illustrating that a cover of the contact part is rotated while the door is opened as the slider is moved forward in FIG. 25.

### MODE OF THE DISCLOSURE

The embodiments described in the present specification and the configurations shown in the drawings are only examples of preferred embodiments of the present disclosure, and various modifications may be made at the time of filing of the present disclosure to replace the embodiments and drawings of the present specification.

Like reference numbers or signs in the various drawings of the application represent parts or components that perform substantially the same functions.

The terms used herein are for the purpose of describing the embodiments and are not intended to restrict and/or to limit the present disclosure. For example, the singular expressions herein may include plural expressions, unless the context clearly dictates otherwise. Also, the terms “comprises” and “has” are intended to indicate that there are features, numbers, steps, operations, components, parts, or combinations thereof described in the specification, and do not exclude the presence or addition of one or more other features, numbers, steps, operations, components, parts, or combinations thereof. Further, for example, the expression “at least one of A and B” may include any of the following: A, B, “A and B,” and the expression “at least one of A. B, and C” may include any of the following: A. B, C, “A and B,” “A and C,” “B and C,” “A and B and C.”

It will be understood that, although the terms first, second, etc. may be used herein to describe various components, these components should not be limited by these terms, and the terms are only used to distinguish one component from another. For example, without departing from the scope of the present disclosure, a first component may be referred to as a second component, and similarly, the second component may also be referred to as a first component. The term “and/or” includes any combination of a plurality of related items or any one of a plurality of related items.

In this specification, the terms “front end,” “rear end,” “upper portion,” “lower portion,” “front surface,” “rear surface,” “upper end” and “lower end” used in the following description are defined with reference to the drawings, and the shape and position of each component are not limited by these terms.

Hereinafter, embodiments of the present disclosure will be described in detail with reference to the accompanying drawings.

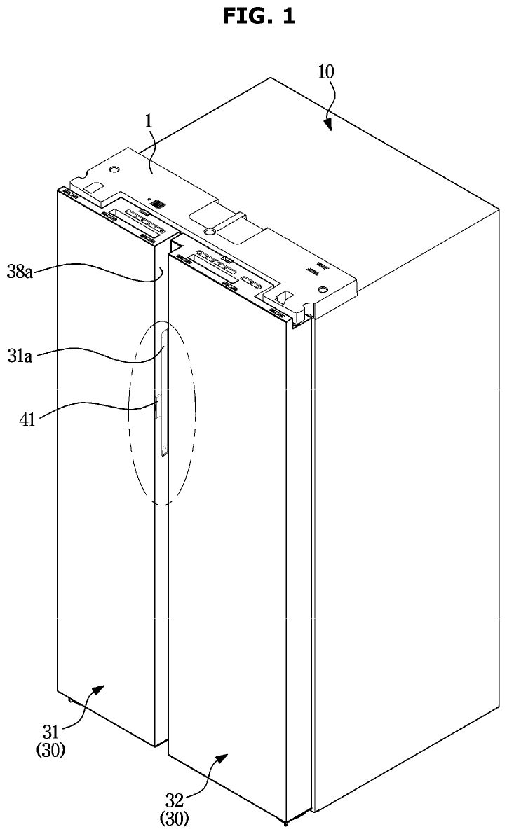

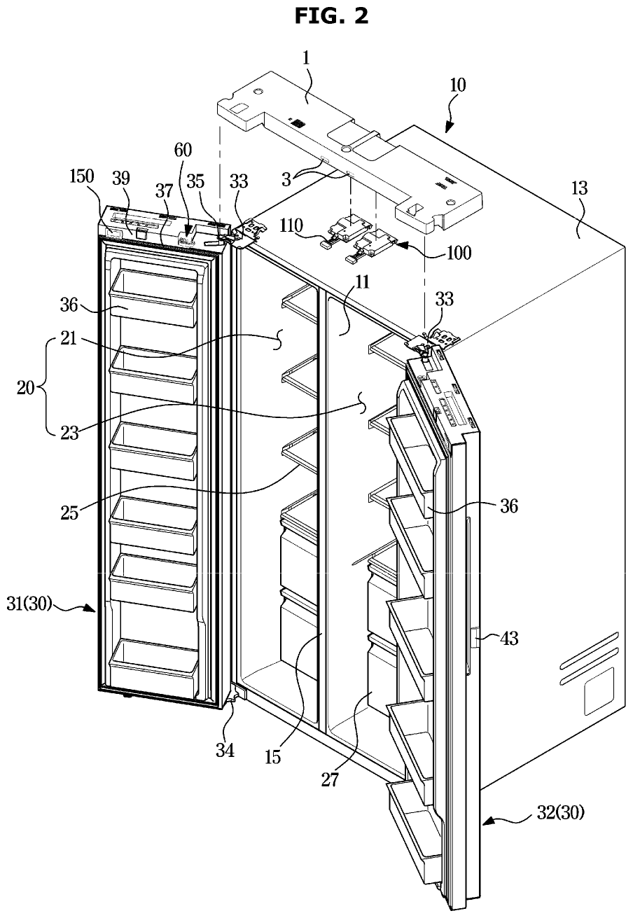

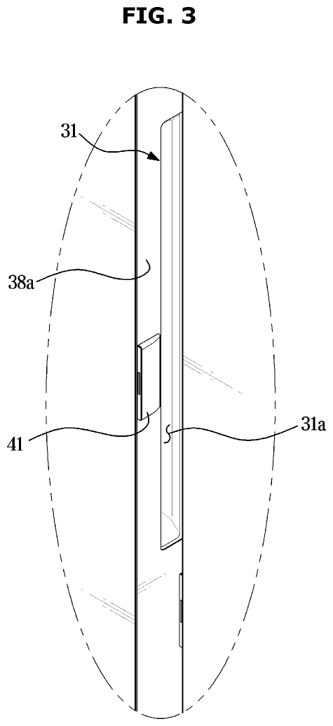

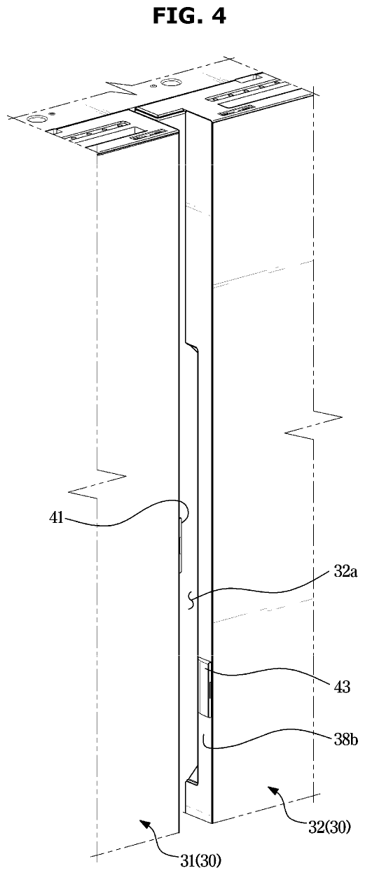

FIG. 1 is a perspective view of a refrigerator according to an embodiment. FIG. 2 is a view illustrating a state in which a door of the refrigerator is opened and a door opening and closing device for opening the door is separated according to an embodiment. FIG. 3 is an enlarged view of a dotted line portion in FIG. 1 illustrating a switch of a first door. FIG. 4 is a view illustrating the switch of the first door and a switch of a second door according to an embodiment.

As illustrated in FIGS. 1 to 4, a refrigerator may include a main body 10, a plurality of storage compartments 20 provided inside the main body 10 so that the front thereof is open, a door 30 provided to open and close the open front of the storage compartment 20, and a cold air supply device (not shown) provided to supply cold air to the inside of the storage compartment 20.

The main body 10 may include an inner case 11 forming the storage compartment 20 and an outer case 13 forming an exterior. An insulator (not shown) may be foamed between the inner case 11 and the outer case 13 and inside the door 30 to prevent leakage of cold air in the storage compartment 20.

The main body 10 may include the cold air supply device provided to supply cold air to the storage compartment 20. The cold air supply device may be configured to include a compressor, a condenser, an expansion valve, an evaporator, a blowing fan, a cold air duct, and the like.

A machine room (not shown) in which the compressor and the condenser provided to compress a refrigerant and condense the compressed refrigerant are installed may be provided at a lower rear side of the main body 10.

The evaporator provided to generate cold air, the blowing fan provided to induce the cool air generated from the evaporator into the storage compartment 20, and the cold air duct provided to guide the cool air generated from the evaporator to the storage compartment 20 may be disposed on a rear wall of the storage compartment 20. A plurality of the evaporators, blowing fans, and cool air ducts may be provided to independently supply cool air to the storage compartment 20, respectively.

The storage compartment 20 may be divided into a storage compartment 21 on a left side and a storage compartment 23 on a right side by the vertical partition wall 15. The storage compartment 21 on the left side may be used as a refrigerating compartment, and the storage compartment 23 on the right side may be used as a freezing compartment. However, the division and use of the storage compartment 20 as described above is only an example, and may not be limited thereto.

A plurality of shelves 25 is provided in the storage compartment 20 to partition the storage compartment 20 into a plurality of compartments. A plurality of storage containers 27 capable of storing food and the like may be provided in the storage compartment 20.

The door 30 is rotatably coupled to the main body 10 to open and close the storage compartment 20. The door 30 may include a first door 31 provided to open and close the refrigerating compartment, which is the storage compartment 21 on the left side, and a second door 32 provided to open and close the freezing compartment, which is the storage compartment 23 on the right side.

Hinges 33 and 34 may be provided on the main body 10 to rotatably couple the door 30 to the main body 10. The hinges 33 and 34 may include a hinge shaft 35 allowing the door 30 to be rotatably coupled to the main body 10. The door 30 may be rotated about the hinge shafts 35. The hinges 33 and 34 may include the upper hinge 33 provided on an upper portion of the main body 10 to allow the door 30 to be rotatably coupled to the main body 10. The hinges 33 and 34 may include the lower hinge 34 provided on a lower portion of the main body 10 to allow the door 30 to be rotatably coupled to the main body 10.

A plurality of door guards 36 capable of storing food and the like may be installed on a rear surface 39 of the door 30. A gasket 37 may be provided on the rear surface 39 of the door 30 to seal the storage compartment 20 by being in close contact with the front of the main body 10 when the door 30 is closed.

A top table 1 may be provided on an upper surface of the main body 10. The top table 1 may cover at least a portion of the upper hinge 33 so that the upper hinge 33 is not exposed to the outside.

A door opening and closing device 100 may be provided inside the top table 1 to open and close the door 30. A part of the door opening and closing device 100 may be accommodated inside the top table 1. The top table 1 may be coupled to the upper surface of the main body 10 in a state in which a part of the door opening and closing device 100 is coupled to the top table 1. A pair of the door opening and closing devices 100 may be provided to correspond to the first door 31 and the second door 32 respectively provided on left and right sides of the main body 10. Because the pair of door opening and closing devices 100 have the same configuration, only one door opening and closing device 100 will be described below.

The door opening and closing device 100 may include a slider 110 provided to open the door 30 by pushing the rear surface 39 of the door 30 forward. The slider 110 may be provided to be movable in a front-rear direction. The door 30 may be opened as the slider 110 moving forward pushes the rear surface 39 of the door 30. That is, the door opening and closing device 100 partially opens the door 30 so that a user may open the door 30 with a small force.

The door opening and closing device 100 may include a magnetic force part 150 provided on the rear surface 39 of the door 30 and to which a front end of the slider 110 is attached. The slider 110 may be moved forward to push the magnetic force part 150 in a state in which the front end is attached to the magnetic force part 150. After the door 30 is partially opened as the slider 110 pushes the magnetic force part 150 in the state of being attached to the magnetic force part 150, when the door 30 is no longer opened, the slider 110 may be moved rearward to close the door 30. A detailed description of the slider 110 and the magnetic force part 150 of the door opening and closing device 100 will be given below.

Although the drawing illustrates that the door opening and closing device 100 is provided on the main body 10 and the slider 110 pushes the rear surface of the door 30, the present disclosure is not limited thereto. That is, the door opening and closing device 100 may be provided on the door 30 so that the slider 110 pushes the front of the main body 10 to open the door 30.

A slider hole 3 through which the slider 110 passes may be formed on a front surface of the top table 1. Because the door opening and closing devices 100 are provided as a pair, the sliders 110 and the magnetic force parts 150 may also be provided as a pair. Therefore, the slider holes 3 may also be formed as a pair to correspond to the number of sliders 110.

A recessed first handle 31a may be formed on a side surface 38a of the first door 31 so that the user may put his or her hand therein and hold the handle. The first handle 31a, which is formed to be recessed into the side surface 38a of the first door 31, may be formed only in partial section between upper and lower ends of the first door 31, not in the entire section. Accordingly, a space remaining except for the partial section occupied by the first handle 31a may be utilized as an inner space of the first door 31, so that the inner space of the first door 31 may be increased.

A recessed second handle 32a may be formed on a side surface 38b of the second door 32 so that the user may put his or her hand therein and hold the handle. The second handle 32a, which is formed to be recessed into the side surface 38b of the second door 32, may be formed only in partial section between upper and lower ends of the second door 32, not in the entire section. Accordingly, a space remaining except for the partial section occupied by the second handle 32a may be utilized as an inner space of the second door 32, so that the inner space of the second door 32 may be increased.

The door opening and closing device 100 may be operated through switches 41 and 43. The user may operate the door opening and closing device 100 by manipulating the switches 41 and 43. According to an embodiment, the switches 41 and 43 may be manipulated by a touch of the user.

The switches 41 and 43 may include the first switch 41 provided on the first door 31 and the second switch 43 provided on the second door 32. The first switch 41 may operate the door opening and closing device 100 to open the first door 31. The second switch 43 may operate the door opening and closing device 100 to open the second door 32.

The first switch 41 may be provided on the side surface 38a of the first door 33. The first switch 41 may be positioned in front of the first handle 31a formed on the side surface 38a of the first door 31. Therefore, the first switch 41 may be touched at the same time that the user holds the first handle 31a with his or her hand.

At least a portion of the first switch 41 may be provided to protrude from the side surface 38a of the first door 33. Due to this structure, the user may hold the first handle 31a more comfortably.

The second switch 43 may be provided on the side surface 38b of the second door 32. The second switch 43 may be positioned in front of the second handle 32a formed on the side surface 38b of the second door 32. Therefore, the user may touch the second switch 43 with his or her hand at the same time that the user holds the second handle 32a with his or her hand.

At least a portion of the second switch 43 may be provided to protrude from the side surface 38b of the second door 33. Due to this structure, the user may hold the second handle 32a more comfortably.

Heights of the first switch 41 and the second switch 43 may be different from each other. Because the height of the first switch 41 and the height of the second switch 43 are different, when the first switch 41 is touched, unintentional touch of the second switch 43 may be prevented. Also, when the second switch 43 is touched, unintentional touch of the first switch 41 may be prevented. Through this, malfunction of the door opening and closing device 100 may be prevented.

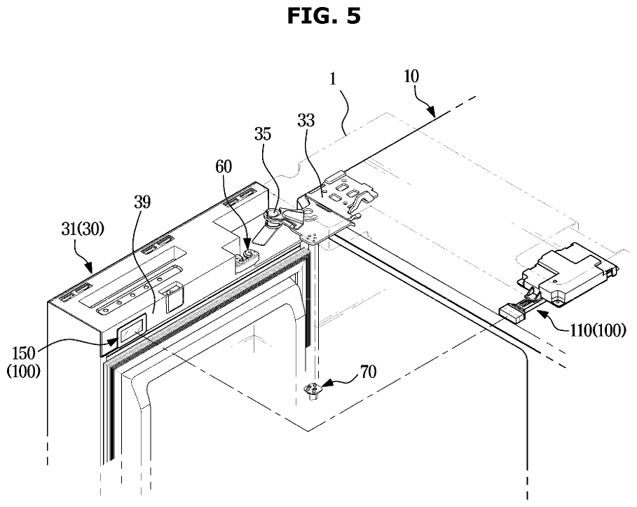

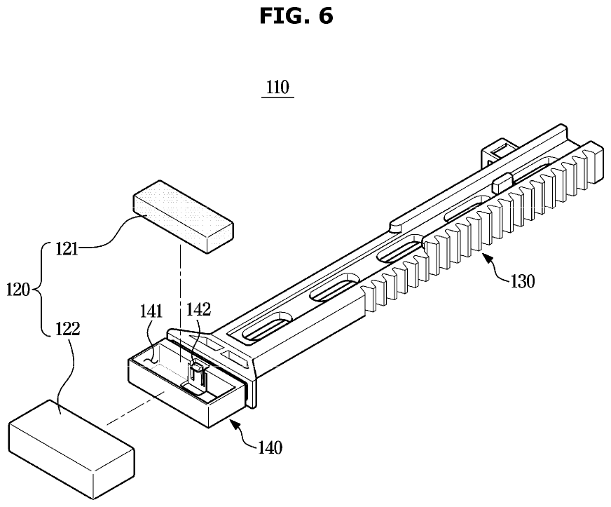

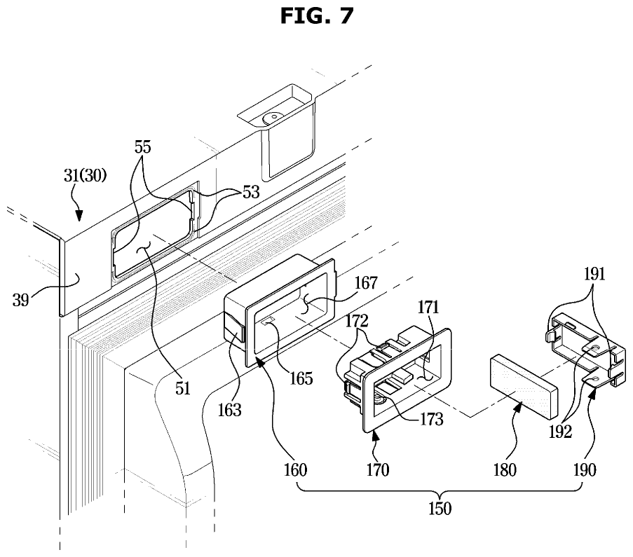

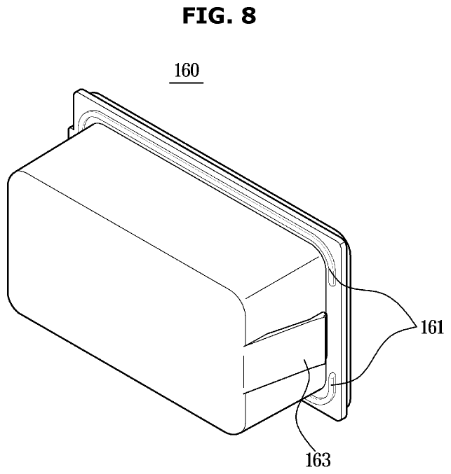

FIG. 5 is a view illustrating that a door opening and closing device is provided on a main body and the door according to an embodiment. FIG. 6 is an exploded view of a slider according to an embodiment. FIG. 7 is a view for explaining a process of assembling a disassembled magnetic force part to a rear surface of the door according to an embodiment. FIG. 8 illustrates a case in FIG. 7 that is viewed from another direction.

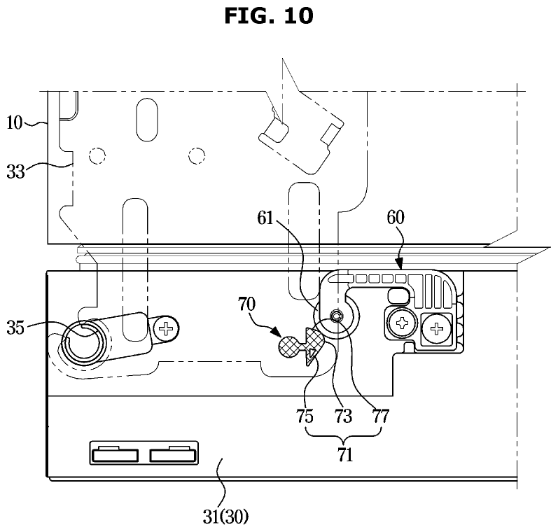

As illustrated in FIGS. 5 to 8, the door opening and closing device 100 may include the slider 110 provided on the main body 10. The slider 110 may be provided at the upper portion of the main body 10. The slider 110 may be provided to be movable in the front-rear direction. The slider 110 is moved forward by a pinion gear (not shown) rotated by a motor (not shown) so that the front end of the slider 110 may push the rear surface 39 of the door 30 forward. That is, the slider 110 may be moved forward so that the front end of the slider 110 is attached to the magnetic force part 150 assembled to the rear surface 39 of the door 30, and may push the magnetic force part 150 in a state in which the front end of the slider 110 is attached to the magnetic force part 150 (see FIG. 10).

The slider 110 may include the contact part 120 provided at the front end of the slider 110. When the slider 110 is moved forward, the contact part 120 may be attached to the magnetic force part 150 assembled to the rear surface 39 of the door 30, and may push the magnetic force part 150 in the state of being attached to the magnetic force part 150. When the contact part 120 pushes the magnetic force part 150, the door 30 may be partially opened (see FIG. 10).

The contact part 120 may include a magnet 121. The magnet 121 may attach the contact part 120 to the magnetic force part 150 by a magnetic force when the slider 110 is moved forward. A closing force of the door 30 may be adjusted by adjusting a size and/or thickness of the magnet 121.

The contact part 120 may include a cover 122 provided to cover the magnet 121. The cover 122 may prevent the magnet 121 from being exposed to the outside. In addition, the cover 122 may prevent the magnet 121 from directly coming into contact with the magnetic force part 150.

The slider 110 may include a rack gear 130 provided to allow the slider 110 to be moved in the front-rear direction. The rack gear 130 is engaged with the pinion gear, and the pinion gear may be rotated by the motor. Therefore, when the pinion gear is rotated by the motor, the rack gear 130 may be moved in the front-rear direction depending on a rotation direction of the pinion gear.

The slider 110 may include a housing 140 in which the magnet 121 is accommodated. The housing 140 may be provided at the front end of the slider 110. The housing 140 may include an opening 141 opened such that the magnet 121 is accommodated in the housing 140. The housing 140 may include a fixing hook 142 to which the magnet 121 accommodated in the housing 140 is fixed.

The door opening and closing device 100 may include the magnetic force part 150 assembled to the rear surface 39 of the door 30. As the contact part 120 of the slider 110 is attached to the magnetic force part 150, the magnetic force part 150 may allow the door 30 to be closed by the slider 110 being moved rearward. The magnetic force part 150 may include a case 160 having an open front and assembled to the rear surface 39 of the door 30. The magnetic force part 150 may include a housing 170 having an open front and fixed to the inside of the case 160. The magnetic force part 150 may include a magnet 180 partially accommodated in the housing 170. The magnetic force part 150 may include a cover 190 provided to be rotatably assembled to the front of the housing 170 in a left-right direction to cover the open front of the housing 170.

The case 160 may be assembled to the rear surface 39 of the door 30. For assembly of the case 160, the door 30 may include an insertion hole 51 formed to allow a portion of the case 160 to be inserted into the rear surface 39 of the door 30. A rear portion of the case 160 may be inserted into the insertion hole 51 formed on the rear surface 39 of the door 30.

The door 30 may include a pair of assembly grooves 53 formed at upper and lower portions of the insertion hole 51, respectively, to allow the case 160 having a portion inserted into the insertion hole 51 to be assembled. The pair of assembly grooves 53 may be formed along an edge of the insertion hole 51 at the upper and lower portions of the insertion hole 51, respectively. The assembly groove 53 formed at the upper portion of the insertion hole 51 among the pair of assembly grooves 53 may be formed such that opposite ends thereof extend to portions of left and right sides of the insertion hole 51. The assembly groove 53 formed at the lower portion of the insertion hole 51 among the pair of assembly grooves 53 may be formed such that opposite ends thereof extend to portions of the left and right sides of the insertion hole 51.

The door 30 may include a pair of assembly portions 55 formed on the left and right sides of the insertion hole 51, respectively, to allow the case 160 having a portion inserted into the insertion hole 51 to be assembled.

The case 160 may include a pair of assembly ribs 161 provided to be assembled by being fitted into the pair of assembly grooves 53 formed on the rear surface 39 of the door 30. The pair of assembly ribs 161 may be formed at a rear edge portion of the case 160 to protrude toward the rear. That is, the pair of assembly ribs 161 may be formed to protrude toward the pair of assembly grooves 53 into which the pair of assembly ribs 161 are fitted and assembled.

The case 160 may include a pair of assembly hooks 163 provided to be assembled by being fitted into the pair of assembly portions 55 formed on the rear surface 39 of the door 30. The pair of assembly hooks 163 may be formed on left and right sides of the case 160, respectively.

The case 160 may include a plurality of fixing grooves 165 to which the housing 170 is fixed. The plurality of fixing grooves 165 may be formed inside the case 160 in order to fix the housing 170 to the inside of the case 160. The plurality of fixing grooves 165 may be formed on an upper surface, a lower surface, a left surface, and a right surface of the inside of the case 160, respectively.

The magnetic force part 150 may include the housing 170 having the open front and fixed to the inside of the case 160. The case 160 may include an accommodation portion 167 in which the housing 170 is accommodated by having the open front. The housing 170 may include an opening 171 provided to accommodate a portion of the magnet 180.

The housing 170 may include a plurality of case fixing hooks 172 provided to be fixed to the plurality of fixing grooves 165 formed in the case 160. The plurality of case fixing hooks 172 may be formed on an upper surface, a lower surface, a left surface, and a right surface of the outside of the housing 170 to correspond to the plurality of fixing grooves 165, respectively. The housing 170 accommodated in the accommodation portion 167 of the case 160 may be fixed to the inside of the case 160 by fixing the plurality of case fixing hooks 172 to the plurality of fixing grooves 165.

The housing 170 may include a pair of rotation protrusions 173 to which the cover 190 is rotatably assembled. The pair of rotation protrusions 173 may be formed to protrude from upper and lower portions of the inside of the housing 170, respectively. The pair of rotation protrusions 173 may be formed at a portion far from the hinge shaft 35 of the door 30 in the left-right direction with respect to a center of the housing 170 inside the housing 170. The cover 190 may be rotated in the left-right direction around the pair of rotation protrusions 173. However, the pair of rotation protrusions 173 are not limited to being formed at a portion far from the hinge shaft 35 of the door 30 in the left-right direction with respect to the center of the housing 170 inside the housing 170. That is, the pair of rotation protrusions 173 may be formed at a portion close to the hinge shaft 35 of the door 30 in the left-right direction with respect to the center of the housing 170 inside the housing 170.

As described above, because the cover 190 is rotated in the left-right direction around the pair of rotation protrusions 173, when the door 30 is opened or closed, the magnetic force part 150 is rotated depending on an angle at which the door 30 is opened or closed so that attachment of the contact part 120 and the magnetic force part 150 may be kept. That is, when the door 30 is opened or closed, the cover 190 of the magnetic force part 150 is rotated at an angle corresponding to the angle at which the door 30 is opened or closed so that attachment of the contact part 120 and the magnetic force part 150 may be kept. That is, when the door 30 is opened or closed in the state in which the contact part 120 is attached to the magnetic force part 150, the cover 190 may be rotated such that the door 30 is opened or closed while the contact part 120 keeps an attachment surface attached to the magnetic force part 150. In a case in which the cover 190 is not rotated such that the door 30 is opened or closed while the contact part 120 keeps the attachment surface attached to the magnetic force part 150 when the door 30 is opened or closed, because the attachment of the contact part 120 and the magnetic force part 150 may be kept, but the contact part 120 and the magnetic force part 150 may not be kept parallel, attachment of only a portion, not surface contact, may be kept. Therefore, in a case in which the cover 190 is rotated such that the door 30 is opened or closed while the contact part 120 keeps the attachment surface attached to the magnetic force part 150 when the door 30 is opened or closed, the contact part 120 and the magnetic force part 150 are kept in a parallel state, and the surface contact may be kept intactly.

The magnetic force part 150 may include the magnet 180. The magnet 180 may attach the contact part 120 to the magnetic force part 150 by a magnetic force when the slider 110 is moved forward. The closing force of the door 30 may be adjusted by adjusting a size and/or thickness of the magnet 180.

The magnetic force part 150 may include the cover 190 rotatably assembled to the front of the housing 170 in the left-right direction. The cover 190 may cover the open front of the housing 170. The cover 190 may include a pair of fixing hooks 191 to which the magnet 180 is fixed. The pair of fixing hooks 191 may be formed on left and right sides of the cover 190, respectively. Because the magnet 180 is fixed to the pair of fixing hooks 191 formed on the cover 190, the magnet 180 may be rotated together with the cover 190. In addition, because the magnet 180 is fixed to the inside of the cover 190, the magnet 180 may be prevented from being exposed to the outside by the cover 190. The magnet 180 may be prevented from directly coming into contact with the contact part 120 of the slider 110 by the cover 190.

The cover 190 may include a pair of rotation holes 192 provided to allow the pair of rotation protrusions 173 formed on the housing 170 to be rotatably assembled. The pair of rotation holes 192 may be formed at upper and lower portions of the cover 190 to correspond to the pair of rotation protrusions 173, respectively.

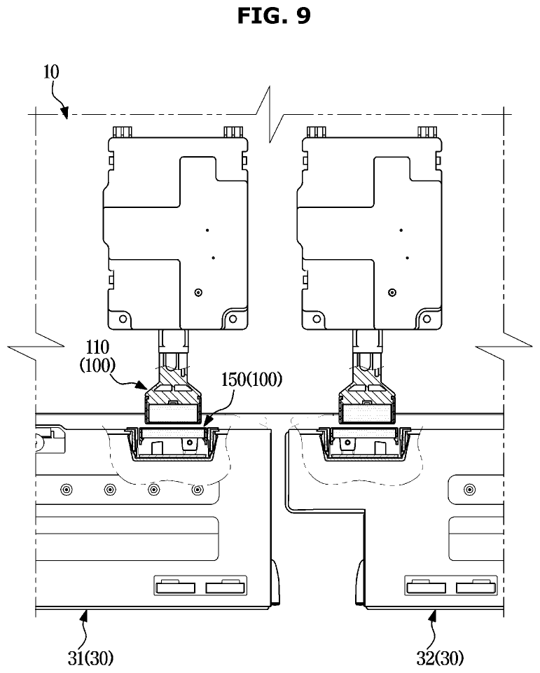

An operation of the door opening and closing device 100 will be described in detail below with reference to FIGS. 9 to 20. Because FIGS. 9 to 17 illustrate for describing an operation of opening and closing the first door 31 by the door opening and closing device 100, the first door 31 will be referred to as the door 30 for convenience.

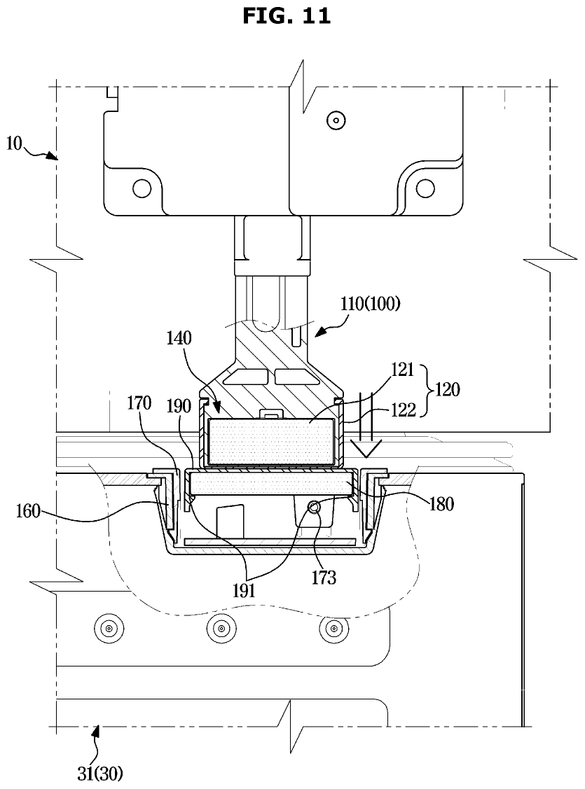

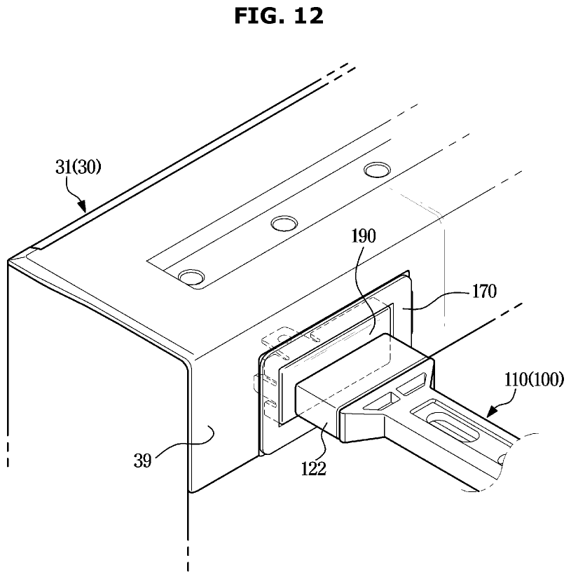

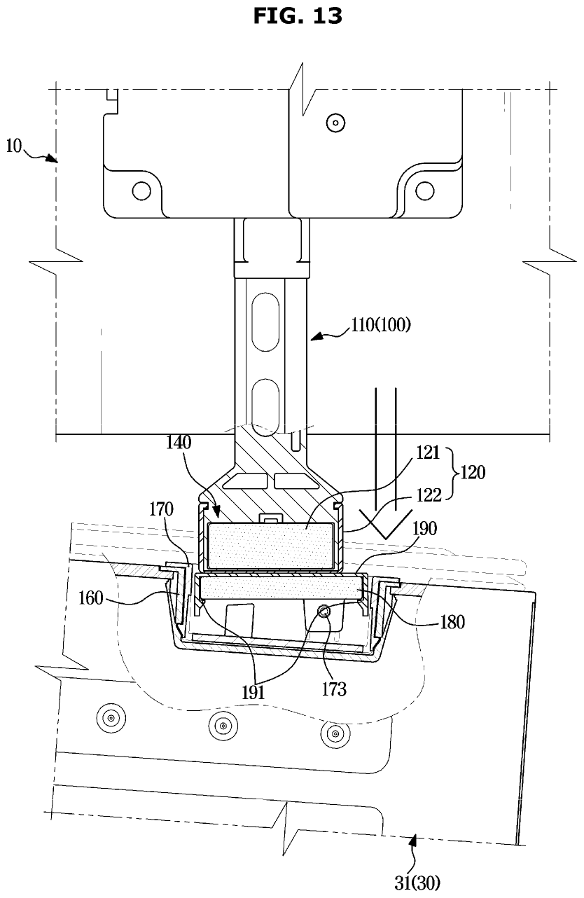

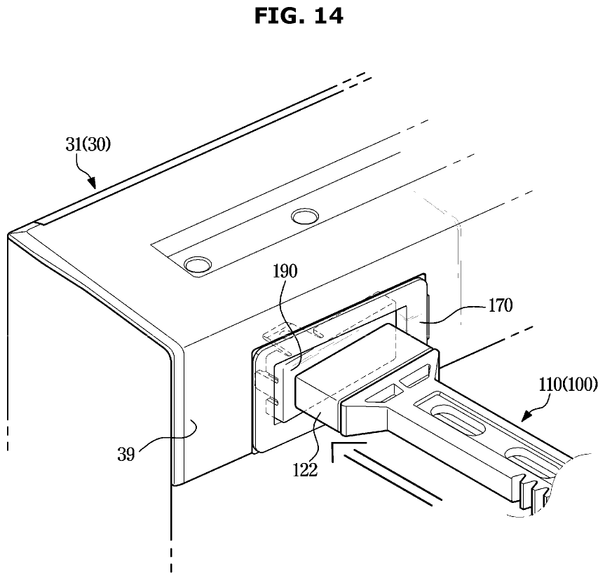

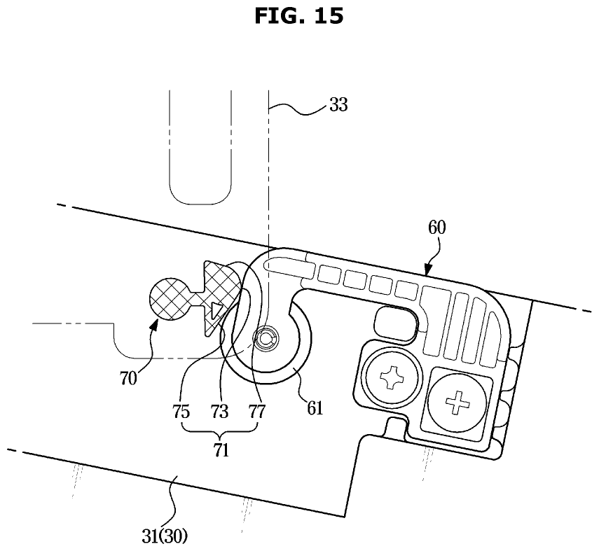

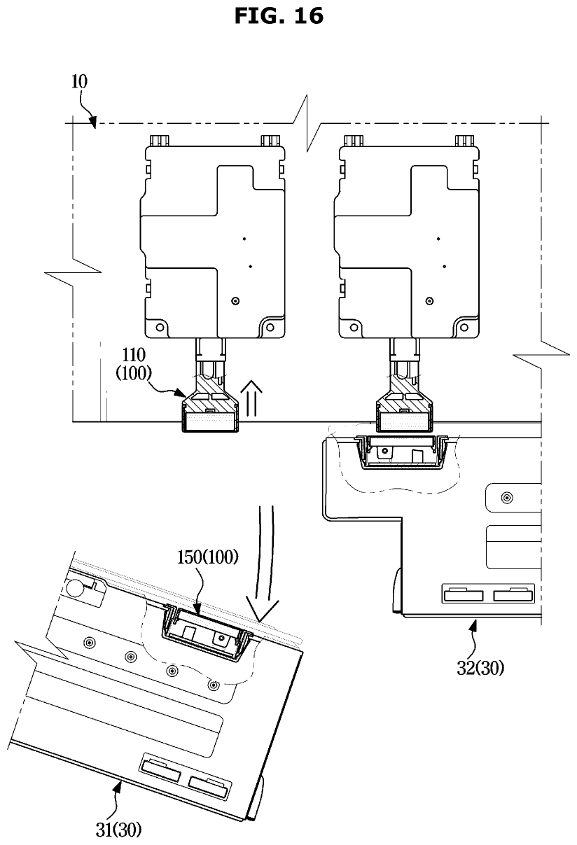

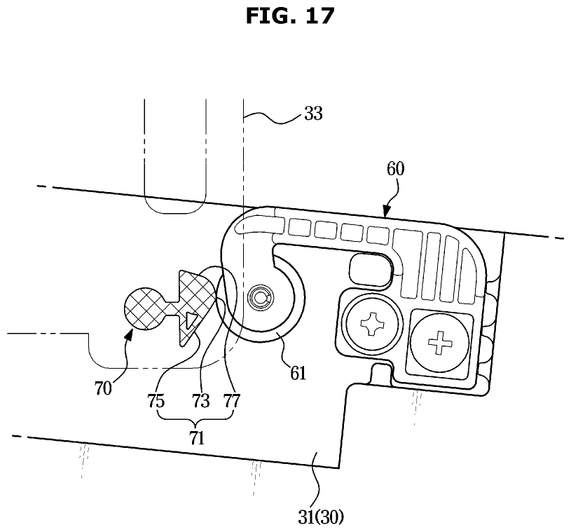

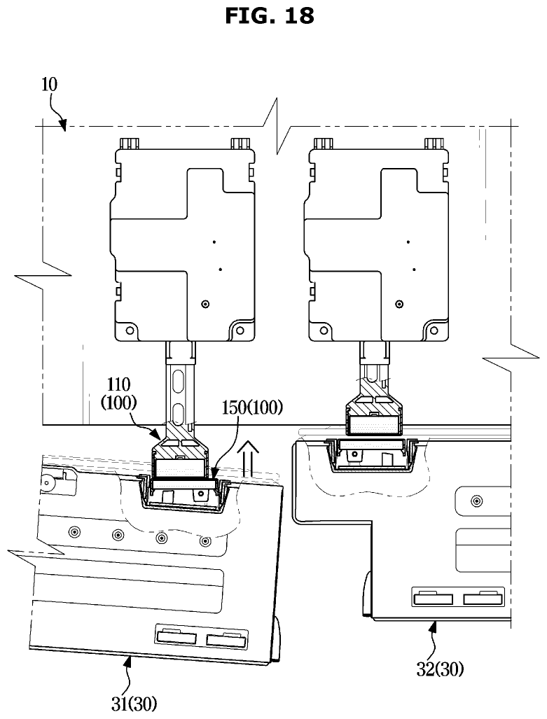

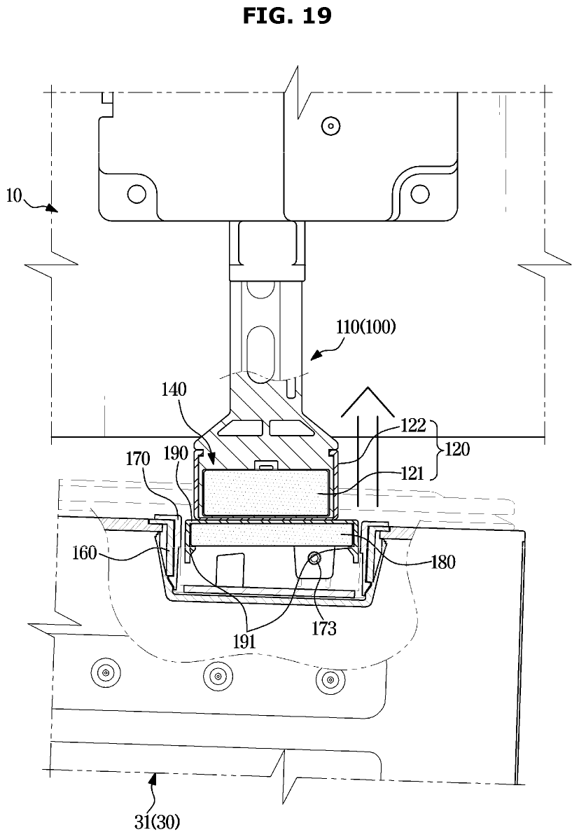

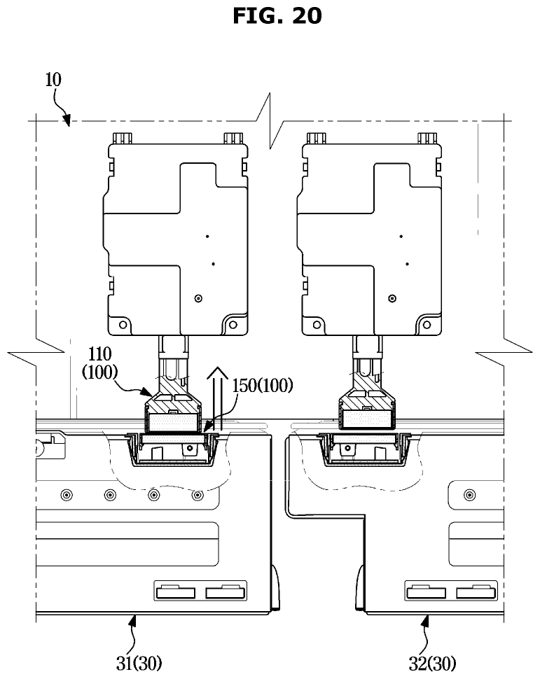

FIG. 9 is a view illustrating a state in which the door is closed according to an embodiment. FIG. 10 is a view illustrating an elastic lever provided at an upper portion of the door and a cam member provided on an upper hinge when the door is closed according to an embodiment. FIG. 11 is a view illustrating a state in which a contact part is attached to the magnetic force part as the slider in FIG. 9 is moved forward. FIG. 12 is a perspective view illustrating the state in which the contact part is attached to the magnetic force part according to an embodiment. FIG. 13 is a view illustrating that a cover of the magnetic force part is rotated while the door is opened as the slider is moved forward in FIG. 11. FIG. 14 is a perspective view illustrating that the cover is rotated in the state in which the contact part is attached to the magnetic force part according to an embodiment. FIG. 15 is a view illustrating states of the elastic lever and the cam member when the door is completely opened according to an embodiment. FIG. 16 is a view illustrating that the door is completely opened in a state in which the door is partially opened by the slider according to an embodiment. FIG. 17 is a view illustrating states of the elastic lever and the cam member when the door is partially opened according to an embodiment. FIG. 18 is a view showing that the door is automatically closed by the slider in the state in which the door is partially opened by the slider according to an embodiment. FIG. 19 is a view illustrating that the cover is rotated while the door is closed by the slider according to an embodiment. FIG. 20 is a view illustrating that the slider returns to an original position thereof while the contact part of the slider is detached from the magnetic force part after the door is closed by the slider according to an embodiment.

As illustrated in FIG. 9, when the door 30 is closed, the contact part 120 of the slider 110 may be in a state of being spaced apart from the magnetic force part 150. In order to partially open the door 30 in a state in which the door 30 is closed, the first switch 41 (see FIG. 3) may be touched to operate the slider 110.

As illustrated in FIG. 10, when the door 30 is closed, the elastic lever 60 provided at the upper portion of the door 30 and the cam member 70 provided on the upper hinge 33 may be in a state of being in contact with each other.

The elastic lever 60 may transfer an elastic force in a direction in which the door 30 is closed so that the door 30 may come into close contact with the main body 10 when the door 30 is closed. As the door 30 comes into close contact with the main body 10 by the elastic lever 60, leakage of cold air in the storage compartment 20 (see FIG. 2) may be prevented.

The elastic lever 60 is formed of a material having elasticity, is provided to be bent in a U shape, and may include a roller 61 in contact with the cam member 70. The roller 61 may be moved along a shape of a cam surface 71 by coming into contact with the cam surface 71 of the cam member 70. The roller 61 may be kept in a state of not being in contact with the cam surface 71 of the cam member 70 when the door 30 is completely opened. When the roller 61 comes into contact with the cam surface 71 in a process in which the door 30 is closed, the elastic lever 60 is compressed to accumulate the elastic force.

When the door 30 is closed, the cam member 70 comes into contact with the roller 61 of the elastic lever 60 so that the elastic lever 60 may accumulate the elastic force. In addition, the cam member 70 transfers the elastic force accumulated by the elastic member 60 to the door 30 in the direction in which the door 30 is closed, so that the door 30 may come into close contact with the main body 10 by the elastic member 60.

The cam member 70 may include the cam surface 71 with which the roller 61 of the elastic lever 60 comes into contact. The cam surface 71 may include an inflection point 73 which is a reference point when the door 30 is opened and closed, a first contact surface 75 and a second contact surface 77 provided on lower and upper sides of the inflection point 73, respectively, to have opposite slopes with respect to the inflection point 73.

When the door 30 is in a completely opened state, a state in which the roller 61 of the elastic lever 60 does not come into contact with the cam surface 71 of the cam member 70 is kept, and the roller 61 may come into contact with the first contact surface 75 of the cam surface 71 in the process in which the door 30 is closed.

The roller 61 come into contact with the first contact surface 75 may be moved along the cam surface 71 while sequentially coming into contact with the first contact surface 75, the inflection point 73, and the second contact surface 77 in the process in which the door 30 is closed. When the roller 61 is moved to the inflection point 73 after coming into contact with the first contact surface 75, the elastic lever 60 may accumulate the elastic force. When the user closes the door 30 enough for the roller 61 to go beyond the inflection point 73, the elastic lever 60 may transfer the accumulated elastic force to the door 30 when the roller 61 is moved from the inflection point 73 to the second contact surface 77. That is, when the user closes the door 30 by transferring a force to the door 30 only enough for the roller 61 of the elastic lever 60 to go beyond the inflection point 73, even when the force of the user is no longer transferred to the door 30, the door 30 may come into close contact with the main body 10 by receiving the elastic force in the direction in which the door 30 is closed. When the door 30 is closed, the roller 61 of the elastic lever 60 may be in a state of being in contact with the second contact surface 77 of the cam member 70.

When the first switch 41 (see FIG. 3) is touched in the state in which the door 30 is closed to operate the slider 110, as illustrated in FIGS. 11 and 12, the slider 110 is moved forward so that the contact part 120 may be attached to the magnetic force part 150. That is, the magnet 121 of the contact part 120 and the magnet 180 of the magnetic force part 150 may be attached by the magnetic force. In this case, the magnet 121 of the contact part 120 and the magnet 180 of the magnetic force part 150 may be prevented from directly come into contact with each other by the covers 122 and 190, respectively.

As illustrated in FIGS. 13 and 14, when the slider 110 is moved further forward in the state in which the contact part 120 is attached to the magnetic force part 150, the contact part 120 pushes the magnetic force part 150 so that the door 30 may be partially opened. At this time, the cover 190 of the magnetic force part 150 may be rotated around the pair of rotation protrusions 173 so as to keep a constant magnetic force between the cover 190 and the contact part 120 according to the opening of the door 30. The cover 190 of the magnetic force part 150 may be rotated around the pair of rotation protrusions 173 so that the contact part 120 and the magnetic force part 150 may be kept parallel according to the opening of the door 30 to come into surface contact with each other. That is, the cover 190 of the magnetic force part 150 may be rotated at an angle corresponding to an opening angle of the door 30 around the pair of rotation protrusions 173 so that the contact part 120 and the magnetic force part 150 may be kept parallel according to the opening of the door 30 to come into surface contact with each other. Because the door 30 is rotated clockwise around the hinge shaft 35 (see FIG. 5), the cover 190 may is rotated counterclockwise around the pair of rotation protrusions 173.

As illustrated in FIG. 15, when the door 30 is partially opened, when the roller 61 of the elastic lever 60 receives a force from the slider 110 (see FIGS. 12 and 13) enough to pass the second contact surface 77 and go beyond the inflection point 73, as illustrated in FIG. 16, the door 30 may be completely opened while the roller 61 of the elastic lever 60 passes the second contact surface 77 and goes over the inflection point 73.

When the door 30 may be completely opened, the slider 110 may return to an original position thereof while the attachment of the contact part 120 and the magnetic force part 150 is released.

As illustrated in FIG. 17, when the door 30 is partially opened, when the roller 61 of the elastic lever 60 receives a force from the slider 110 (see FIGS. 12 and 13) to the extent that the roller 61 passes the second contact surface 77 and does not go beyond the inflection point 73, but is caught on the inflection point 73, the door 30 may not be opened any more, and may be kept in a partially opened state.

When the door 30 is stopped in an only partially opened state by the slider 110, as illustrated in FIG. 18, the slider 110 may automatically be moved rearward and return to the original position. That is, the slider 110 may return to a position when the door 30 is closed. However, the present disclosure is not limited thereto, and when the door 30 is stopped in a state where the door 30 is only partially opened by the slider 110, the slider 110 may be moved rearward and return to the original position by a manipulation of the user. For example, the user may touch the switch or the like to operate the slider 110 to be moved rearward.

When the slider 110 is moved rearward, as illustrated in FIG. 19, because the contact part 120 and the magnetic force part 150 of the slider 110 is kept in the state of being attached to each other, the door 30 may be rotated in the closing direction by the magnetic force of the magnets 121 and 180. That is, the door 30 may be rotated counterclockwise around the hinge shaft 35 (see FIG. 5). At this time, the cover 190 of the magnetic force part 150 may be rotated around the pair of rotation protrusions 173 so that the attachment of the cover 190 and the contact part 120 may be kept according to the closing of the door 30. The cover 190 of the magnetic force part 150 may be rotated around the pair of rotation protrusions 173 so that the contact part 120 and the magnetic force part 150 may be kept parallel to come into surface contact with each other according to the closing of the door 30. That is, the cover 190 of the magnetic force part 150 may be rotated at an angle corresponding to a closing angle of the door 30 around the pair of rotation protrusions 173 so that the contact part 120 and the magnetic force part 150 may be kept parallel to come into surface contact with each other according to the closing of the door 30. That is, when the door 30 is closed in the state in which the contact part 120 is attached to the magnetic force part 150, the cover 190 of the magnetic force part 150 may be rotated so that the contact part 120 is closed while keeping the attachment surface attached to the magnetic force part 150. Because the door 30 is rotated counterclockwise around the hinge shaft 35 (see FIG. 5), the cover 190 may be rotated clockwise around the pair of rotation protrusions 173.

As illustrated in FIG. 20, when the slider 110 is moved rearward and the door 30 is completely closed, the attachment of the contact part 120 and the magnetic force part 150 of the slider 110 is released, and the slider 110 may return to the original position.

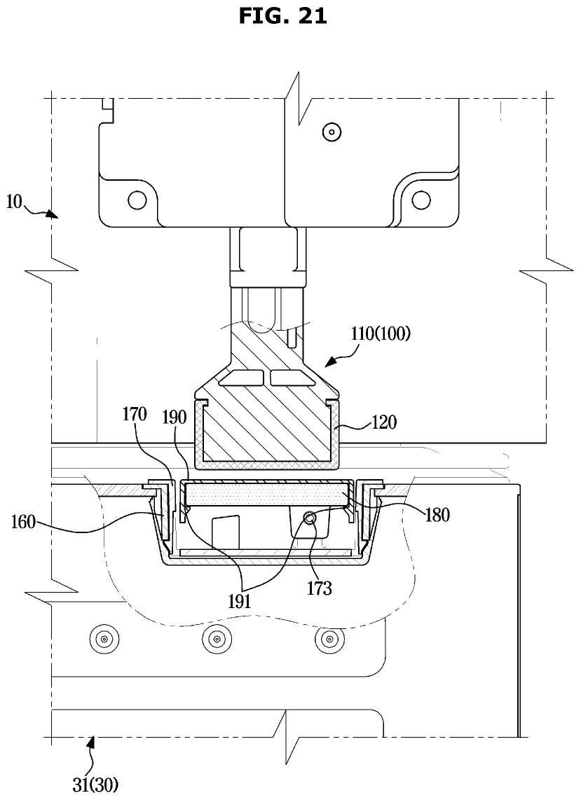

FIG. 21 is a view illustrating that the magnetic force part is provided with a magnet, and the contact part is not provided with a magnet, but is provided with a cover made of iron, according to an embodiment.

As illustrated in FIG. 21, the magnet 180 may be provided only on the magnetic force part 150. In this case, the cover 122 of the contact part 120 may be formed of iron so that the contact part 120 may be attached to the magnetic force part 150. A configuration of the housing 140 may be the same as that of the housing 140 illustrated in FIG. 6 except that the configuration of the fixing hook 142 (see FIG. 6) for fixing the magnet 121 (see FIG. 6) is deleted. The remaining configurations of the slider 110 except for the configuration of the housing 140 may be the same as those of the slider 110 illustrated in FIG. 6.

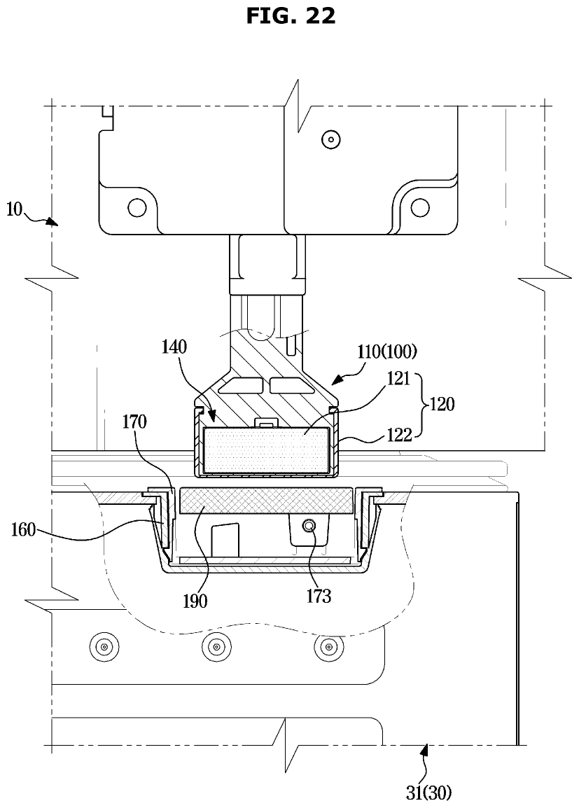

FIG. 22 is a view illustrating that the contact part is provided with the magnet, and the magnetic force part is not provided with the magnet, but is provided with the cover made of iron, according to an embodiment.

As illustrated in FIG. 22, the magnet 121 may be provided only on the contact part 120. In this case, the cover 190 of the magnetic force part 150 may be formed of iron so that the contact part 120 may be attached to the magnetic force part 150. A configuration of the cover 190 may be the same as that of the cover 190 illustrated in FIG. 7 except that the configuration of the pair of fixing hooks 191 (see FIG. 7) for fixing the magnet 180 (see FIG. 7) is deleted. The remaining configurations of the magnetic force part 150 except for the configuration of the cover 190 may be the same as those of the magnetic force part 150 illustrated in FIGS. 7 and 8.

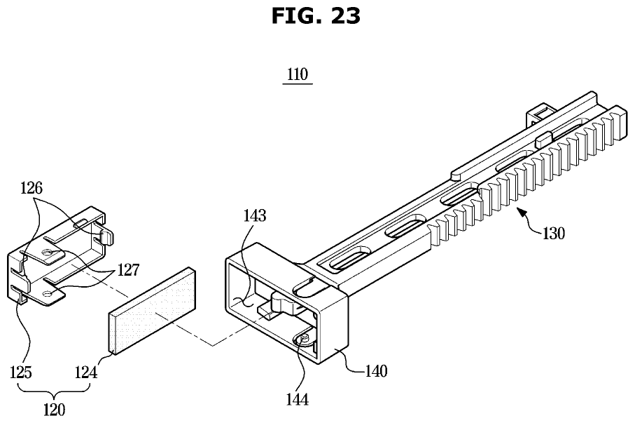

FIG. 23 is an exploded view illustrating the slider according to an embodiment.

As illustrated in FIG. 23, the slider 110 may include the contact part 120 provided at the front end of the slider 110. When the slider 110 is moved forward, the contact part 120 may be attached to the magnetic force part 150 assembled to the rear surface 39 of the door 30 and push the magnetic force part 150 in the state of being attached to the magnetic force part 150. When the contact part 120 pushes the magnetic force part 150, the door 30 may be partially opened (see FIG. 11).

The contact part 120 may include a magnet 124. When the slider 110 is moved forward, the magnet 124 may attach the contact part 120 to the magnetic force part 150 by a magnetic force. The closing force of the door 30 may be adjusted by adjusting a size and/or thickness of the magnet 124.

The contact part 120 may include a cover 125 rotatably assembled to the front of the housing 140, which will be described below. The cover 125 may cover the magnet 124 to prevent the magnet 124 from being exposed to the outside. In addition, the cover 125 may prevent the magnet 124 from directly coming into contact with the magnetic force part 150.

The cover 125 may include a pair of fixing hooks 126 to which the magnet 124 is fixed. The pair of fixing hooks 126 may be formed on left and right sides of the cover 125, respectively. Because the magnet 124 is fixed to the pair of fixing hooks 126 formed on the cover 125, the magnet 124 may be rotated together with the cover 125. In addition, because the magnet 124 is fixed to the inside of the cover 125, the magnet 124 may be prevented from being exposed to the outside by the cover 125. The magnet 124 may be prevented from directly coming into contact with the magnetic force part 150 by the cover 125.

The cover 125 may include a pair of rotation holes 127 into which a pair of rotation protrusions 144 formed on the housing 140 are rotatably assembled. The pair of rotation holes 127 may be formed at upper and lower portions of the cover 125 to correspond to the pair of rotation protrusions 144, respectively.

The slider 110 may include the rack gear 130 provided to allow the slider 110 to be moved in the front-rear direction. The rack gear 130 is engaged with the pinion gear, and the pinion gear may be rotated by the motor. Therefore, when the pinion gear is rotated by the motor, the rack gear 130 may be moved in the front-rear direction depending on the rotation direction of the pinion gear.

The slider 110 may include the housing 140 in which the magnet 124 is accommodated. The housing 140 may be provided at the front end of the slider 110. The housing 140 may include an opening 143 opened such that the magnet 124 is accommodated in the housing 140.

The housing 140 may include the pair of rotation protrusions 144 to which the cover 125 is rotatably assembled. The pair of rotation protrusions 144 may be formed to protrude from upper and lower portions of the housing 140, respectively. The pair of rotation protrusions 144 may be formed at a portion far from the hinge shaft 35 of the door 30 in the left-right direction with respect to a center of the housing 140 inside the housing 140. The cover 125 may be rotated in the left-right direction around the pair of rotation protrusions 144. However, as described above, the pair of rotation protrusions 144 are not limited to being formed at a portion far from the hinge shaft 35 of the door 30 in the left-right direction with respect to the center of the housing 140 inside the housing 140. That is, the pair of rotation protrusions 144 may be formed at a portion close to the hinge shaft 35 of the door 30 in the left-right direction with respect to the center of the housing 140 inside the housing 140 (see FIG. 5).

As described above, because the cover 125 is rotated in the left-right direction around the pair of rotation protrusions 144, when the door 30 is opened or closed, the contact part 120 is rotated depending on an angle at which the door 30 is opened or closed so that the attachment of the contact part 120 and the magnetic force part 150 may be kept. That is, when the door 30 is opened or closed, the cover 125 of the contact part 120 is rotated at an angle corresponding to the angle at which the door 30 is opened or closed so that the attachment of the contact part 120 and the magnetic force part 150 may be kept. That is, when the door 30 is opened or closed, the cover 125 of the contact part 120 may be rotated such that the door 30 is opened or closed while the contact part 120 keeps an attachment surface attached to the magnetic force part 150. In a case in which the cover 125 is not rotated depending on the angle at which the door 30 is opened or closed when the door 30 is opened or closed, because the attachment of the contact part 120 and the magnetic force part 150 may be kept, but the contact part 120 and the magnetic force part 150 may not be kept parallel, attachment of only a portion, not surface contact, may be kept. Therefore, in a case in which the cover 125 is rotated depending on the angle at which the door 30 is opened or closed when the door 30 is opened or closed, the contact part 120 and the magnetic force part 150 are kept in a parallel state, and the surface contact may be kept intactly.

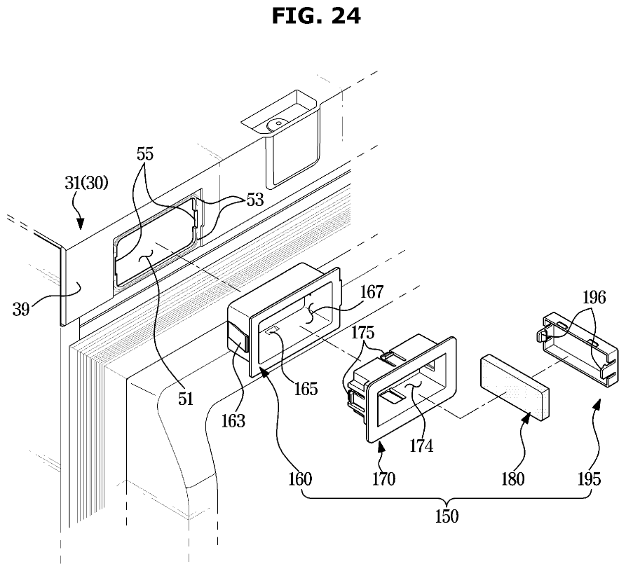

FIG. 24 is a view for explaining a process of assembling a disassembled magnetic force part to the rear surface of the door according to an embodiment.

As illustrated in FIG. 24, the magnetic force part 150 may include the case 160 having an open front and assembled to the rear surface 39 of the door 30. The magnetic force part 150 may include the housing 170 having an open front and fixed to the inside of the case 160. The magnetic force part 150 may include the magnet 180 partially accommodated in the housing 170. The magnetic force part 150 may include a cover 195 provided to be assembled to the front of the housing 170 to cover the open front of the housing 170.

The case 160 may be assembled to the rear surface 39 of the door 30. For assembly of the case 160, the door 30 may include the insertion hole 51 formed to allow a portion of the case 160 to be inserted into the rear surface 39 of the door 30. A rear portion of the case 160 may be inserted into the insertion hole 51 formed on the rear surface 39 of the door 30.

The door 30 may include the pair of assembly grooves 53 formed at the upper and lower portions of the insertion hole 51, respectively, to allow the case 160 having a portion inserted into the insertion hole 51 to be assembled. The pair of assembly grooves 53 may be formed along an edge of the insertion hole 51 at the upper and lower portions of the insertion hole 51, respectively. The assembly groove 53 formed at the upper portion of the insertion hole 51 among the pair of assembly grooves 53 may be formed such that the opposite ends thereof extend to portions of the left and right sides of the insertion hole 51. The assembly groove 53 formed at the lower portion of the insertion hole 51 among the pair of assembly grooves 53 may be formed such that the opposite ends thereof extend to portions of the left and right sides of the insertion hole 51.

The door 30 may include the pair of assembly portions 55 formed on the left and right sides of the insertion hole 51, respectively, to allow the case 160 having a portion inserted into the insertion hole 51 to be assembled.

The case 160 may include the pair of assembly ribs 161 provided to be assembled by being fitted into the pair of assembly grooves 53 formed on the rear surface 39 of the door 30. The pair of assembly ribs 161 may be formed at a rear edge portion of the case 160 to protrude toward the rear. That is, the pair of assembly ribs 161 may be formed to protrude toward the pair of assembly grooves 53 into which the pair of assembly ribs 161 are fitted and assembled (see FIG. 8).

The case 160 may include the pair of assembly hooks 163 provided to be assembled by being fitted into the pair of assembly portions 55 formed on the rear surface 39 of the door 30. The pair of assembly hooks 163 may be formed on the left and right sides of the case 160, respectively.

The case 160 may include the plurality of fixing grooves 165 to which the housing 170 is fixed. The plurality of fixing grooves 165 may be formed inside the case 160 in order to fix the housing 170 to the inside of the case 160. The plurality of fixing grooves 165 may be formed on the upper surface, the lower surface, the left surface, and the right surface of the inside of the case 160, respectively.

The magnetic force part 150 may include the housing 170 having the open front and fixed to the inside of the case 160. The case 160 may include the accommodation portion 167 in which the housing 170 is accommodated by having the open front. The housing 170 may include an opening 174 provided to accommodate a portion of the magnet 180.

The housing 170 may include a plurality of case fixing hooks 175 provided to be fixed to the plurality of fixing grooves 165 formed in the case 160. The plurality of case fixing hooks 175 may be formed on the upper surface, the lower surface, the left surface, and the right surface of the outside of the housing 170 to correspond to the plurality of fixing grooves 165, respectively. The housing 170 accommodated in the accommodation portion 167 of the case 160 may be fixed to the inside of the case 160 by fixing the plurality of case fixing hooks 175 to the plurality of fixing grooves 165.

The magnetic force part 150 may include the magnet 180. The magnet 180 may attach the contact part 120 to the magnetic force part 150 by the magnetic force when the slider 110 is moved forward. The closing force of the door 30 may be adjusted by adjusting the size and/or thickness of the magnet 180.

The magnetic force part 150 may include the cover 195 rotatably assembled to the front of the housing 170. The cover 195 may cover the open front of the housing 170. The cover 195 may include a pair of fixing hooks 196 to which the magnet 180 is fixed. The pair of fixing hooks 196 may be formed on left and right sides of the cover 195, respectively. Because the magnet 180 is fixed to the inside of the cover 195, the magnet 180 may be prevented from being exposed to the outside by the cover 195. The magnet 180 may be prevented from directly coming into contact with the contact part 120 of the slider 110 by the cover 195.

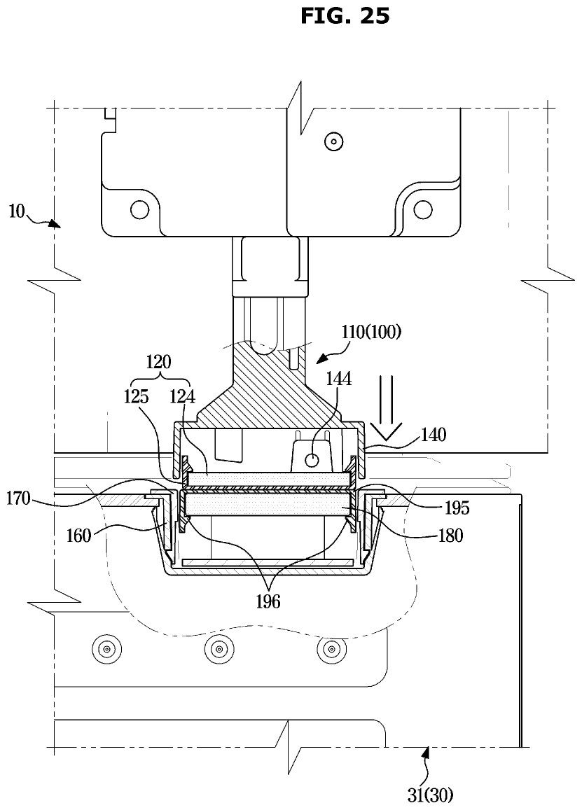

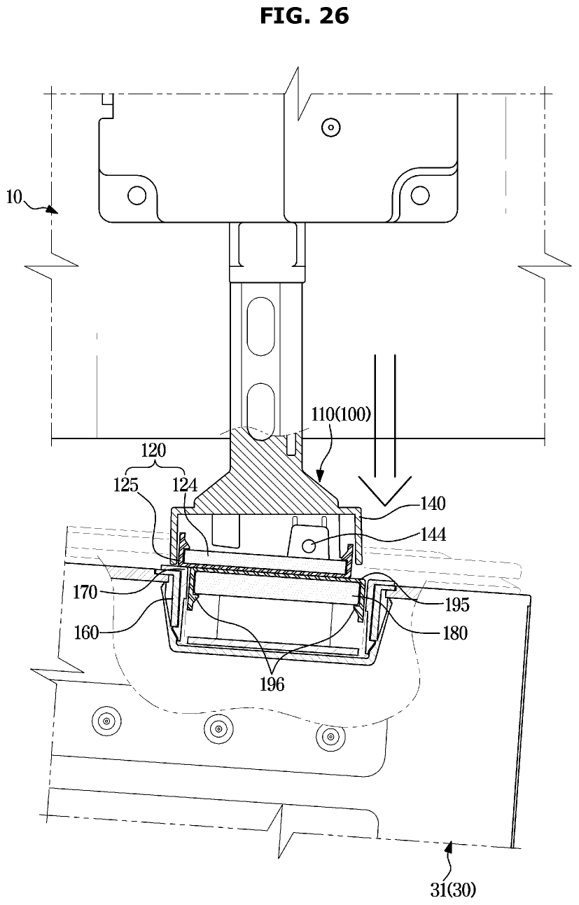

FIG. 25 is a view illustrating a state in which a contact part is attached to a magnetic force part as the slider is moved forward in the state in which the door is closed according to an embodiment. FIG. 26 is a view illustrating that a cover of the contact part is rotated while the door is opened as the slider is moved forward in FIG. 25.

As illustrated in FIG. 25, when the first switch 41 (see FIG. 3) is touched in the state in which the door 30 is closed to operate the slider 110, the slider 110 is moved forward so that the contact part 120 may be attached to the magnetic force part 150. That is, the magnet 124 of the contact part 120 and the magnet 180 of the magnetic force part 150 may be attached by the magnetic force. In this case, the magnet 124 of the contact part 120 and the magnet 180 of the magnetic force part 150 may be prevented from directly come into contact with each other by the covers 125 and 195, respectively.

As illustrated in FIG. 26, when the slider 110 is moved further forward in the state in which the contact part 120 is attached to the magnetic force part 150, the contact part 120 pushes the magnetic force part 150 so that the door 30 may be partially opened. At this time, the cover 125 of the contact part 120 may be rotated around the pair of rotation protrusions 144 so that the attachment with the magnetic force part 150 may be kept according to the opening of the door 30. The cover 125 of the contact part 120 may be rotated around the pair of rotation protrusions 144 so that the contact part 120 and the magnetic force part 150 may be kept parallel according to the opening of the door 30 to come into surface contact with each other. That is, the cover 125 of the contact part 120 may be rotated at an angle corresponding to an opening angle of the door 30 around the pair of rotation protrusions 144 so that the contact part 120 and the magnetic force part 150 may be kept parallel according to the opening of the door 30 to come into surface contact with each other. Because the door 30 is rotated clockwise around the hinge shaft 35 (see FIG. 5), the cover 125 may is rotated clockwise around the pair of rotation protrusions 144.

Although not shown in the drawings, when the contact part 120 and the magnetic force part 150 are kept in a parallel state according to the opening and closing of the door 30, both the contact part 120 and the magnetic force part 150 may be rotated according to the opening and closing of the door 30. Also, both the contact part 120 and the magnetic force part 150 may not be rotated. When both the contact part 120 and the magnetic force part 150 is not rotated, the slider 110 may be formed to have the same trajectory as a trajectory on which the door 30 is rotated according to the opening and closing of the door 30. That is, the slider 110 is formed in an arc shape having a curvature rather than a straight bar, so that the slider 110 may be moved along the same trajectory as the trajectory on which the door 30 is rotated.

Although the specific shape and direction have been mainly described in the description of the refrigerator with reference to the accompanying drawings, these may be variously modified and changed by those skilled in the art, and these modifications and changes are to be interpreted as being included in the scope of the rights of the present disclosure.

What is claimed is:

1. A refrigerator comprising:
a main body having a storage compartment;
a door rotatably coupled to the main body to open or close the storage compartment;
a slider provided on the main body, configured to be movable in a front-rear direction to open or close the door, the slider comprising a contact part; and
a magnetic force part installed to a rear surface of the door, configured to be magnetically attachable to or detachable to the contact part by a movement of the slider,
wherein the door is configured to be opened or closed by the slider while the magnetic force part is magnetically attached to the contact part, and
wherein at least one of the contact part and a part of the magnetic force part is configured to be rotatable so that while an attachment of the magnetic force part and the contact part is maintained.

2. The refrigerator according to claim 1, wherein the slider further comprises:
a rack gear to allow the slider to be movable in the front-rear direction; and
a housing provided at a front end of the slider, and having an opening.

3. The refrigerator according to claim 2, wherein the contact part comprises:
a magnet partially accommodated in the housing; and
a cover to cover the opening of the housing, and rotatably coupled to the housing so that the cover is configured to be rotatable with respect to the housing while the magnetic force part is magnetically attached to the contact part.

4. The refrigerator according to claim 3, wherein
the housing further comprises a pair of rotation protrusions formed at an upper portion and a lower portion of inside of the housing, respectively, so that the cover is rotatably coupled to the pair of rotation protrusions.

5. The refrigerator according to claim 4, wherein the main body comprises a hinge shaft to which the door is rotatably coupled, and the pair of rotation protrusions are formed at a portion away from the hinge shaft of the door in a left-right direction with respect to a center of the housing.

6. The refrigerator according to claim 5, wherein
the cover comprises:
a pair of rotation holes to which the pair of rotation protrusions are rotatably coupled; and
a pair of fixing hooks to which the magnet is fixed therebetween.

7. The refrigerator according to claim 6, wherein
the magnet is accommodated between the cover and the housing so that the magnet is prevented from being exposed to outside of the slider, and the magnet is fixed to the pair of fixing hooks to be rotated together with the cover.

8. The refrigerator according to claim 1, wherein
the magnetic force part comprises:
a case having an opening, and installed to the rear surface of the door;
a housing having an opening, and accommodated inside of the case by inserting into the opening of the case;
a magnet partially accommodated in the housing; and
a cover to cover the opening of the housing, and rotatably coupled to the housing so that the cover is configured to be rotatable with respect to the housing while the magnetic force part is magnetically attached to the contact part.

9. The refrigerator according to claim 8, wherein
the door comprises:
an insertion hole formed on the rear surface of the door to allow a portion of the case to be inserted;
a pair of assembly grooves formed at an upper portion and a lower portion of the insertion hole, respectively, to allow the case to be installed; and
a pair of assembly portions formed on a left side and a right side of the insertion hole, respectively, to allow the case to be installed.

10. The refrigerator according to claim 9, wherein
the case further comprises:
an accommodation portion having an open front to accommodate the housing;
a pair of assembly ribs provided at an upper portion and a lower portion of a rear surface of the case, respectively, to be installed into the pair of assembly grooves; and
a pair of assembly hooks provided on a left side and a right side of the rear surface of the case, respectively, to be installed into the pair of assembly portions.

11. The refrigerator according to claim 10, wherein
the case further comprises a plurality of fixing grooves, and
the housing further comprises:
a plurality of case fixing hooks fixed to the plurality of fixing grooves; and
a pair of rotation protrusions provided at an upper portion and a lower portion of inside of the housing, respectively, so that the cover is rotatably coupled to the pair of rotation protrusions.

12. The refrigerator according to claim 11, wherein the main body comprises a hinge shaft to which the door is rotatably coupled, and
the pair of rotation protrusions are formed at a portion away from a hinge shaft of the door in a left-right direction with respect to a center of the housing.

13. The refrigerator according to claim 12, wherein
the cover further comprises:
a pair of rotation holes to which the pair of rotation protrusions are rotatably coupled; and
a pair of fixing hooks to which the magnet is fixed therebetween.

14. The refrigerator according to claim 13, wherein
the magnet is accommodated between the cover and the housing so that the magnet is prevented from being exposed to outside of the magnetic force part, and the magnet is fixed to the pair of fixing hooks to be rotated together with the cover.

15. The refrigerator according to claim 1, wherein
the door comprises:
a first door and a second door provided on a left side and a right side of the main body, respectively, and
the slider and the magnetic force part are provided as a pair to each of the first door and the second door.
